(19) United States
(12) Patent Application Publication
(10) Pub. No.: US 2024/0005200 A1
(43) Pub. Date: Jan. 4, 2024

(54) GENERATION OF INFERENCE LOGIC FROM TRAINING-TIME ARTIFACTS FOR MACHINE LEARNING MODEL DEPLOYMENTS

(71) Applicant: Oracle International Corporation, Redwood Shores, CA (US)

(72) Inventors: Kripa Kanchana Sivakumar, Seattle, WA (US); Andrew Ioannou, San Francisco, CA (US); John James Backof, II, Tiburon, CA (US); Tzvi Keisar, Redmond, WA (US)

(73) Assignee: Oracle International Corporation, Redwood Shores, CA (US)

(21) Appl. No.: 17/853,744

(22) Filed: Jun. 29, 2022

(51) Int. Cl. G06N 20/00

(52) U.S. Cl. CPC G06N 20/00

(57) ABSTRACT

A system is disclosed that includes capabilities for generating a Machine Learning (ML) inference pipeline for deploying an ML model using artifacts received from one or more training stages in an ML training pipeline. The system receives one or more artifacts for one or more training stages in a set of training stages in a ML training pipeline associated with an ML process. The system then identifies one or more inference stages in an ML inference pipeline that correspond to the one or more training stages in the ML training pipeline. For each inference stage that corresponds to a training stage, the system associates the artifact received for the training stage with the inference stage. The system then generates the ML inference pipeline comprising the inference stages and their associated artifacts, where the artifacts include the artifacts received for the training stages in the ML training pipeline.

### BACKGROUND

Machine learning (ML) is an important component in the growing field of data science. In a machine learning process, an ML model is trained to make classifications or predictions using data to discover key patterns in the data. Executing an end-to-end ML process involves the orchestration of a sequence of steps that are taken to train and deploy an ML model. Each step performs a specific function like processing the data, extracting signals/features from the processed data, training a model using the data, evaluating the trained model and deploying the model. The ML process typically evolves as new data is gathered over time and thus needs to be re-executed periodically. Authoring a sequence of well-defined steps in an ML process and orchestrating these steps in a managed environment is a complex process. There is thus a need for making the techniques related to defining and executing ML processes more efficient than is possible in existing implementations.

### BRIEF SUMMARY

The present disclosure relates generally to machine learning (ML) processes, and more particularly, to techniques for generating inference logic and a model endpoint for launching an ML model into production from training code received from one or more training stages in an ML training process.

A system is disclosed that includes capabilities for generating an ML inference pipeline for deploying an ML model using artifacts received from one or more training stages in an ML training pipeline. The system receives one or more artifacts for one or more training stages in a set of training stages in a Machine Learning (ML) training pipeline associated with a Machine Learning (ML) process. The system then identifies one or more inference stages in a Machine Learning (ML) inference pipeline associated with the ML process that correspond to the training stages in the ML training pipeline. For each inference stage that corresponds to a training stage, the system associates the artifact received for the training stage with the inference stage. The system then generates the ML inference pipeline comprising the inference stages and their associated artifacts, where the artifacts include the artifacts received for the training stages in the ML training pipeline.

In certain examples, the artifacts represent code, a set of instructions, a script, or a configuration file that identifies processing to be performed for one or more training stages in the ML training pipeline. The artifacts may include a pre-processing artifact, a trained model artifact and a post-processing artifact. The pre-processing artifact identifies pre-processing to be performed for a pre-processing training stage in the ML training pipeline. The trained model artifact identifies processing to be performed for a model training stage in the ML training pipeline. The post-processing artifact identifies post-processing to be performed for a post-processing training stage in the ML training pipeline.

In certain examples, the system provides a set of Application Programming Interfaces (APIs), where an API in the set of APIs identifies the processing to be performed for a particular training stage in the set of training stages in the ML training pipeline.

In certain examples, the system generates a package that implements the ML inference pipeline, where the package includes the artifacts associated with the inference stages in the ML inference pipeline. The system then deploys the package in an inference environment, wherein an inference server implemented in the inference environment executes the deployed package which is then used to generate inferences on real time data.

In certain examples, an inference server receives a request for a prediction for a set of one or more input datapoints and executes the package that implements the inference pipeline. The package comprises the inference stages and their associated artifacts where the artifacts comprise the artifacts received for the training stages in the ML training pipeline.

In certain examples, the inference server executes a pre-processing artifact in the package to pre-process the set of one or more datapoints to generate a set of pre-processed datapoints. The inference server then executes a trained model artifact in the package using the set of pre-processed datapoints to generate the prediction. The inference server then executes a post-processing artifact in the package to post-process the prediction generated by the trained model artifact.

In certain examples, the system serializes the artifacts received for the training stages prior to associating the artifacts with the inference stages.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts a computing environment including a training pipeline to inference pipeline mapping system that includes capabilities for generating an ML inference pipeline for deploying an ML model using artifacts received from one or more training stages in an ML training pipeline, according to certain embodiments.

FIG. 2 depicts an ML training pipeline that is composed of multiple pre-processing training stages, in accordance with certain embodiments.

FIG. 3 depicts an example of a process by which the mapping system shown in FIG. 1 generates and deploys a package that implements the inference pipeline using artifacts received from one or more training stages in a ML training pipeline, according to certain embodiments.

FIG. 4 depicts an example of a process 400 that describes the operations performed by an inference server for executing a package that implements an ML inference pipeline using artifacts received from one or more training stages in a ML training pipeline, according to certain embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to machine learning (ML) processes, and more particularly, to techniques for generating inference logic and a model endpoint for launching an ML model into production from training code received from one or more training stages in an ML training process.

A machine learning (ML) process comprises a sequence of steps that are taken to train and deploy a machine learning (ML) model. An ML model refers to a model that is trained by the ML process to recognize certain types of patterns from data. An ML process is generally made up of two distinct modes of operation, an offline mode (also referred to as an ML training process) and an online mode (also referred to as an ML inference process). The ML training process is composed of several steps that are taken to train an ML model. In certain examples, the ML training process may be represented as an ML training pipeline comprising a set of stages (or steps) that are performed to train an ML model. Each stage performs a specific set of operations in the ML training process such as pre-processing the training data, using the pre-processed data to train the ML model, post-processing the predictions that are output by the ML model, evaluating the trained ML model, and so on.

The online mode, also known as the ML inference process, is responsible for making predictions from a trained ML model generated during the ML training process. During the ML inference process, the trained ML model generated during the training process is used to draw conclusions from new data. For instance, the model generated during the ML training process may be trained to predict if an email is spam or nor spam. During the ML inference process, the trained ML model is used to infer from a new email, whether the new email is spam or not spam. The ML inference process may be represented as an ML inference pipeline that is composed of a set of stages that represent the ML inference process. Each stage performs a specific set of operations in the ML inference process such as pre-processing the data that is received in real time, using the trained ML model to make predictions using the pre-processed data, and post-processing the predictions generated by the ML model.

Oftentimes, the online mode and the offline mode in an ML process are treated as independent, or mutually exclusive processes or systems. For instance, as part of the ML training process, users generally write code to perform the various steps of the ML training process such as preprocessing the training data, training the ML model using the preprocessed data, postprocessing the prediction generated by the ML model and so on. When the ML model gets deployed for inference at the end of the ML training pipeline, users typically re-write the code that performs the inference processing logic and post processing logic so that the trained model can be made available as an endpoint for serving predictions in real-time. However, the training code that is written for one or more stages in the training process are usually shared with an inference-time process during runtime. For example, code that is written for pre-processing a training dataset and code that is written for post-processing predictions generated from a model is usually the same as the pre-processing code and the post processing code that is written at inference time. Writing this code twice, once during the training process and again during the inference process involves considerable manual effort on the part of the user and typically requires a whole lot of computing resources and time.

Apart from having to maintain duplicate logic (code) across training and inference code paths, users (e.g., engineers) also have to deal with complex release processes where changes to an existing model and the inference code need to be coordinated and deployed. Any deviation in code and data in the offline mode results in deviation in model performance that is harder to spot and debug in the online mode. In addition, the ML process isn't “one and done” and on the contrary is a constant needle-moving process whereby continuous optimization on the business objectives is necessary for successful model deployment.

The disclosed system includes capabilities to enable a user to carry the training-time logic over to the inference process such that the logic (code) that was authored during training can be re-used by the user as inference code in the ML inference pipeline with minimal to no user intervention. The disclosed system receives one or more artifacts for one or more training stages in an ML training pipeline. The artifacts may represent code, a set of instructions, a script, or a configuration file that identifies processing to be performed for one or more training stages in the ML training pipeline. In certain examples, the artifacts include a pre-processing artifact that identifies pre-processing that is performed on the training data, a trained model artifact that identifies processing that is performed to generate a trained model and a post-processing artifact that identifies post-processing that is performed on the predictions generated by the trained model.

The system receives the artifacts and serializes the artifacts by persisting (storing) the artifacts as binary files, for example, in persistent memory in the system. The system then identifies one or more stages in a ML inference pipeline that correspond to the training stages in the ML training pipeline. For each inference stage that corresponds to a training stage, the system associates the artifact received for the training stage with the inference stage and generates an inference pipeline comprising the identified inference stages and their associated artifacts. The system then generates a package that implements the inference pipeline, where the package includes the artifacts associated with the inference stages in the inference pipeline. The package is readily deployable as an inference endpoint to serve an end-user (or customer) of the system with minimal to no customer intervention. The system then deploys the package in a runtime environment such that an inference server can execute the package without the customer having to author any inference code.

The disclosed system provides an end-to-end managed solution that takes training artifacts received from an ML training pipeline and generates inference logic and a model endpoint for launching an ML model into production. By re-using artifacts generated during the training process in the inference process, a customer does not have to author the logic pertaining to the inference-time orchestration in the inference pipeline as the relationship between these stages (containers) are fetched from how the training workload was authored. Existing solutions that perform model inferencing typically require a customer of the system to provide packaged code (artifacts) in addition to a trained model artifact (code) to create a model endpoint for making inferences. Thus, a customer typically has to author the inference logic separately so that the trained model artifact can be made available as an endpoint for serving predictions in real-time. By using the functionality provided by the disclosed system, the training-time logic can be carried over to the inference process such that the code that was authored during training results in a package that is readily servable with minimal to no customer intervention. Since the package contains the artifacts that identify the pre-processing and the post-processing to be performed during the inference time and the artifacts are persisted with the trained model artifact, an inference server can just load the package to create a model endpoint for launching a ML model into production and thus reduce the operation time required by customers for launching a model into production

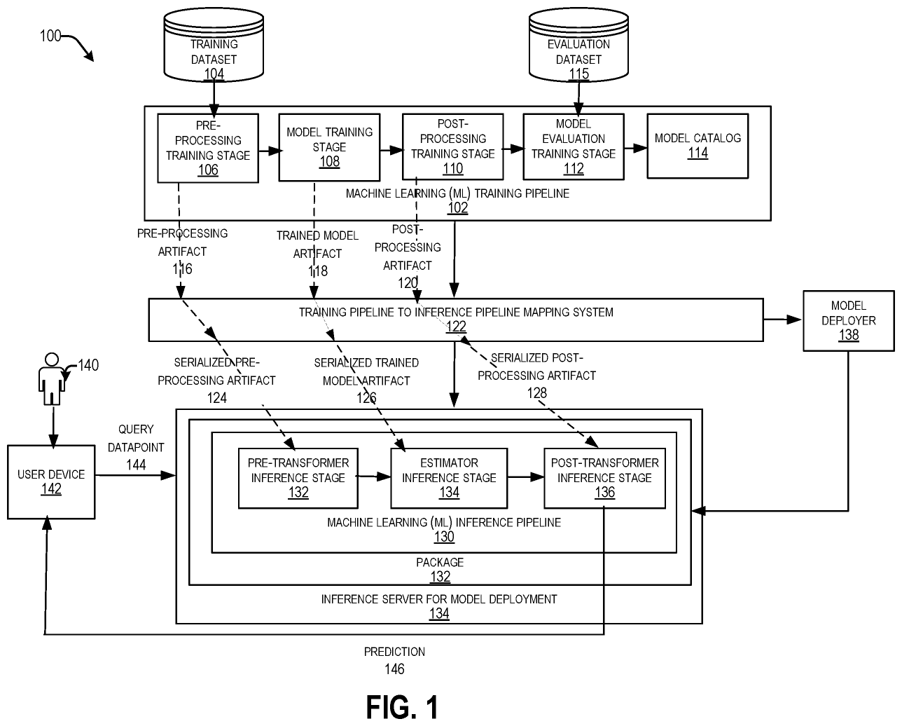

Referring now to the drawings, FIG. 1 depicts a computing environment 100 including a training pipeline to inference pipeline mapping system 122 that includes capabilities for generating an ML inference pipeline for deploying an ML model using artifacts received from one or more training stages in an ML training pipeline, according to certain embodiments. The computing environment 100 additionally includes an ML training pipeline 102, an ML inference pipeline 130 and a model deployer 138. The ML training pipeline 102, the training pipeline to inference pipeline mapping system 122 (also referred to herein as the mapping system 122), and the ML inference pipeline 130 may be implemented by one or more computing systems that execute computer-readable instructions (e.g., code, program) to implement the systems. The systems depicted in FIG. 1 may be implemented using software (e.g., code, instructions, program) executed by one or more processing units (e.g., processors, cores) of a computing system, hardware, or combinations thereof. The software may be stored on a non-transitory storage medium (e.g., on a memory device).

The ML training pipeline 102, the mapping system 122, and the ML inference pipeline 130 may be implemented in various different configurations. In certain embodiments, the systems 102, 122 and 130 may be implemented on one or more servers of a cloud provider network and their services may be provided to subscribers (i.e., customers) of cloud services on a subscription basis. The services may include, for instance, generating inference logic and a model endpoint for launching a ML model into production using training code generated from an ML training pipeline. Details of the operations performed by the various systems in computing environment 100 are described in detail below.

Computing environment 100 depicted in FIG. 1 is merely an example and is not intended to unduly limit the scope of claimed embodiments. One of ordinary skill in the art would recognize many possible variations, alternatives, and modifications. For example, in some implementations, the computing environment 100 can be implemented using more or fewer systems and subsystems than those shown in FIG. 1, may combine two or more subsystems, or may have a different configuration or arrangement of subsystems.

As previously noted, an ML training process may be represented as an ML training pipeline 102 that is composed of multiple training stages. In the embodiment depicted in FIG. 1, the training stages in an ML training pipeline 102 comprise a pre-processing training stage 106, a model training stage 108, a post-processing training stage 110, and a model evaluation training stage 112. In the pre-processing training stage 106, a training dataset 104 that is used to train an ML model is pre-processed. Preprocessing a training dataset 104 may include, but is not limited to, removing or replacing sensitive information (e.g., personally identifiable information) in the dataset with generic information, preparing and cleaning the data (to remove errors in the data), performing data validation checks on the data, adding data to the training dataset (e.g., calculating average or mean values of data points in the dataset) and so on. In certain examples, preprocessing the training dataset 104 may involve creating normalized views that are expected by the ML model training stage in the training pipeline, performing missing value imputations, performing dimensionality reductions, performing sampling of the dataset, and the like.

The pre-processing to be performed on a training dataset 104 in the pre-processing training stage 106 may be defined either via code or configuration by a customer (e.g., a user) of the mapping system 122. In a certain implementation, the mapping system 122 may provide the customer with a Software Development Kit (SDK) comprising a set of standardized interfaces (Application Programming Interfaces) to write the code that identifies the processing to be performed for the various training stages in the ML training process. For instance, the customer may use a pre-processing API in the SDK to write pre-processing code (logic) for the pre-processing training stage. A pre-processing API may, for example, identify input processors that are configured to connect to an object store to process different formats of datasets like (cvs, tsv, jsonl, etc.) and create a normalized view of the data for the next stage in the ML training pipeline. The outcome of the preprocessing training stage is a preprocessed dataset that is used for training an ML model in the model training stage. In certain examples, the mapping system 122 is configured to receive a pre-processing artifact (i.e., the pre-processing code) that identifies the pre-processing to be performed for the pre-processing training stage 106 and serializes the preprocessing artifact (i.e., persists or stores the artifact as a binary file) to generate a serialized pre-processing artifact 124.

The next stage in the ML training pipeline is a model training stage 108. In this stage, an ML model is trained using the preprocessed training dataset generated by the pre-processing training stage 106 and an ML algorithm. The ML algorithm may include a supervised learning algorithm like regression and classification, an unsupervised algorithm such as clustering, decision tress, a Support Vector Machine (SVM) algorithm, a Neural Network and so on. The ML algorithm can be distributed depending on the nature of the ML model that is being trained. The ML algorithm used to train the ML model may be selected based on the type of training dataset, the problem setup and the compute instance(s) used to perform the model training. In certain embodiments, a customer may use an API from the SDK that identifies processing to be performed to generate a trained model artifact. The outcome of this stage is a trained model artifact (also referred to herein as a trained ML model) that can be saved in a model catalog 114 in the ML training pipeline 102. A trained model artifact may represent code (files) comprising trained parameters, a model definition that describes how to compute inferences and other metadata that is necessary for model deployment. In certain embodiments, the mapping system 122 receives the trained model artifact 118 that is created by the model training stage 108 and serializes the trained model artifact 118 by persisting (storing) the artifact as a binary file in persistent memory of the mapping system to generate a serialized trained model artifact 126.

In the post processing training stage, the customer writes post-processing code that identifies post-processing (e.g., downstream processing) to be performed on the prediction(s) generated by the trained model in the model training stage. For instance, if the ML model is trained to predict if an email message is spam, the postprocessing code may include padding the prediction with a recommendation to send the email message to a spam directory so that the entity which uses this system may take an appropriate action. To write the post-processing code, the user may utilize an API (from the SDK provided by the mapping system) that identifies the post-processing to be performed for the post-processing stage. The outcome of this stage is a post-processing artifact (e.g., post-processing code). In certain embodiments, the mapping system 122 receives the post-processing artifact 120 and serializes the post-processing artifact by persisting (storing) the artifact as a binary file to generate a serialized post-processing artifact 128.

In the model evaluation training stage 122, the trained model artifact 118 that is generated during the model training stage 108 is evaluated to generate predictions. The trained and evaluated model artifact is then published to the model catalog 114. By virtue of going through evaluation logic, the created trained model artifact will be serialized accurately, thus being successful in terms of a model deployment. The model evaluation training stage 112 accepts an evaluation dataset 115, the trained model artifact 118 (produced from the model training stage 108) and a set of metrics. The model evaluation stage 112 then compares the labels presented in the evaluation dataset to the outcome from the predictions generated by the trained model artifact and calculates a set of metrics. The outcome of the model evaluation stage 112 is a set of metrics or statistics that can be packaged as part of the model's metadata. The set of metrics present useful information about the offline characteristics of the model and this information can be presented to a customer via a dashboard. In certain examples, a customer may utilize an API provided by the mapping system 122 to write customized metrics during the model evaluation training stage 112. Apart from validating the ML objectives of the model, a successful execution of model evaluation is a validation that the model can be loaded and inferred within a model deployment. In certain examples, the code written for evaluation in the training pipeline is not used in by any inference stage in the ML inference pipeline. Once a trained model artifact is ready for use it is published to the model catalog 114 which is a repository that stores similar inference pipelines as well as other trained model artifacts.

Upon receiving the pre-processing artifact 116, the trained model artifact 118, and the post-processing artifact 120 from one or more training stages in the ML training pipeline 102 as described above, the mapping system 122 compiles the artifacts into executable files and serializes (stores) the artifacts in persistent memory of the mapping system. The mapping system 122 then identifies the inference stages in the ML inference pipeline 130 that correspond to the training stages in the ML training pipeline 130. In a certain implementation, the mapping system 122 may utilize a set of mapping rules stored by the system to identify the inference stages in an inference pipeline that correspond to the training stages in the training pipeline. For example, in the embodiment depicted in FIG. 1, the mapping system 122 may identify, based on the mapping rules, that the pre-processing training stage 106 corresponds to the pre-transformer inference stage 132, the model training stage 108 corresponds to the estimator inference stage 134 and the post-processing training stage 110 corresponds to the post-transformer inference stage 136 in the inference pipeline.

For each inference stage that corresponds to a training stage, the mapping system 122 associates the artifact received for the training stage with the inference stage. For example, the pre-processing artifact 116 received by the mapping system 122 for the pre-processing training stage (which is serialized by the mapping system 122 to generate a serialized pre-processing artifact 124) is associated with the pre-transformer inference stage 132 in the ML inference pipeline. Similarly, the serialized trained model artifact 126 is associated with the estimator inference stage 134 and the serialized post-processing artifact 128 is associated with the post-transformer inference stage 126 in the ML inference pipeline 130. As will be described in more detail below, pre-transformer inference stage 132 is configured to pre-process a set of one or more datapoints to be used by the trained model, the estimator inference stage 134 comprises the trained ML model used to make predictions using the pre-processed set of datapoints, and the post-transformer inference stage 136 post-processes the predictions generated by the ML model.

As previously described, the SDK provides a library of APIs that can be implicitly re-used by the mapping system 122 during the inference process. In order to re-use the library of APIs during inference time and to ensure consistency during the inference process, a set of constraints are applied by the mapping system 122 on the input dataset that is provided to the ML training pipeline and the query datapoint 144 (or query dataset) that is provided to the ML inference pipeline. Examples of constrains include, but are not limited to, providing the input dataset (training dataset) to the pre-processing training stage and the query dataset to the pre-transformer inference stage in the same format (e.g., line separated), providing the input offline schema of a line in the input dataset in the same format as the online schema of the query dataset and so on.

After associating the artifacts received for the training stages with their corresponding inference stages as described above, the mapping system 122 generates an ML inference pipeline 130 comprising the identified inference stages (e.g., 132, 134 and 136) and their associated artifacts (e.g., 124, 126 and 128) respectively. In certain examples, the inference stages 132, 134 and 136 may be implemented as a linear sequence of containers that are configured to process inference (prediction) requests. The mapping system 122 then generates a package 132 that implements the ML inference pipeline 130, where the package 132 includes the serialized artifacts (124, 126, and 128) associated with the inference stages in the inference pipeline. The mapping system 122 then deploys the package 132 in an inference environment where an inference server 134 implemented in the inference environment can execute the package 132 to generate inferences using real time data. In certain embodiments, the package 132 may be deployed by a model deployer 128 in the computing environment 100. For instance, the mapping system 122 may communicate with a model deployer 138 by providing information associated with identified inference stages (e.g., 132, 134 and 136) and their associated artifacts (e.g., 124, 126 and 128). The model deployer 138 may then be configured to deploy the package in a runtime environment (i.e., an inference environment) where the package 132 is executed to make inferences (predictions) using real time data.

For instance, in the embodiment depicted in FIG. 1, a user 140 (e.g., a customer) may transmit a request for prediction for an input (query) datapoint 144 or an input (query) dataset (comprising a set of one or more input data points) via a user device 142 to an inference endpoint (address or URL) of the inference server 134. The user device may be of various types, including but not limited to, a mobile phone, a tablet, a desktop computer, and the like. The inference server 134 receives the request and executes the package 132 that implements the ML inference pipeline 130. As previously described, since the package 132 is composed of artifacts associated with the inference stages 132, 134 and 136 in the inference pipeline, where the artifacts are received from the training stages, the inference server 134 can just load (execute) the package 132 and the package is readily servable to the user with minimal or no user intervention and without the user having to author any code to facilitate the inference process. The inference server 132 executes the package by executing the serialized pre-processing artifact 124 to pre-process the query datapoint (or query dataset). The inference server 132 then executes the serialized trained model artifact 126 using the pre-processed query datapoint (or dataset) to generate a prediction (or multiple predictions) and then executes the serialized post-processing artifact 128 to post-process the prediction(s) 146 generated by the trained model.

The disclosed mapping system 122 thus provides an end-to-end managed solution that takes training artifacts received from an ML training pipeline and generates inference logic and a model endpoint for launching a ML model into production. By re-using artifacts generated during the training process in the inference process, a customer (user) does not have to author the logic pertaining to the inference-time orchestration across the containers implemented in the inference pipeline as the relationship between these stages (containers) are fetched from how the training workload was authored. As previously noted, existing solutions that perform model inferencing typically require a customer to provide packaged code (artifacts) in addition to a trained model artifact (code) to create a model endpoint for making inferences. Thus, a customer typically has to author the inference logic separately so that the trained model artifact can be made available as an endpoint for serving predictions in real-time. By using the functionality provided by the disclosed mapping system 122, the training-time logic can be carried over to the inference process such that the code that was authored during training results in a package that is readily servable with minimal to no customer intervention. Since the package contains the artifacts that identify the pre-processing and the post-processing to be performed during the inference time and the artifacts are persisted with the trained model artifact, an inference server can just load the package to create a model endpoint for launching an ML model into production and thus reduce the operation time required by customers for launching a model into production.

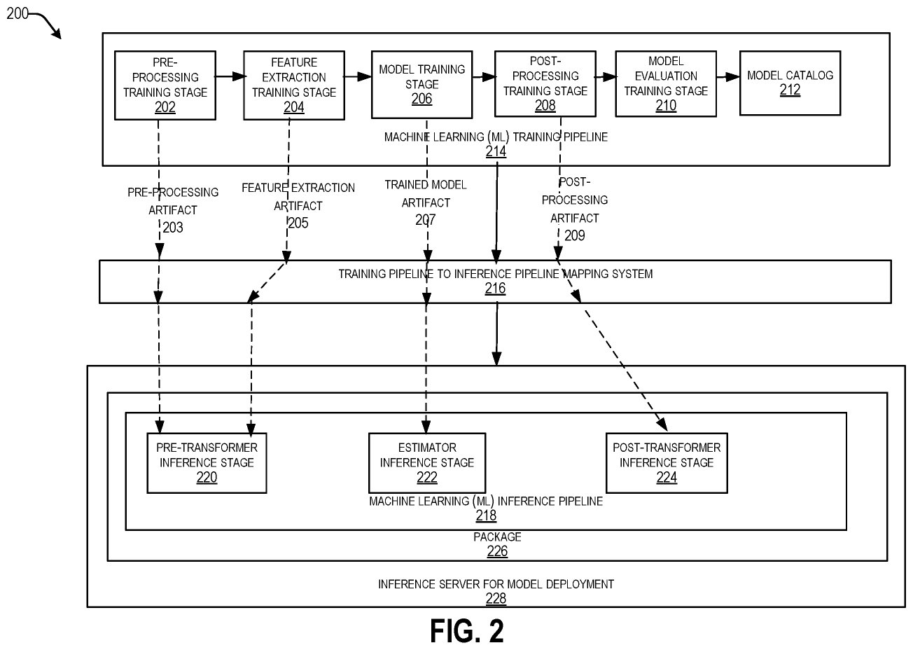

In the embodiment depicted in FIG. 1, the ML training pipeline 102 included a single pre-processing training stage 106. In alternate approaches, the ML training pipeline 102 may be composed of one or more additional pre-processing stages such as a feature extraction training stage, a feature selection training stage, a data validation training stage, a data preparation training stage and so on. FIG. 2 depicts an ML training pipeline that is composed of multiple pre-processing training stages, in accordance with certain embodiments. In the embodiment depicted in FIG. 2, the ML training pipeline 214 includes a first pre-processing training stage 202 followed by a second pre-processing stage 204 (i.e., a feature extraction training stage 204). The first pre-processing training stage 202 is similar to the pre-processing training stage 106 described in in FIG. 1. For instance, in the pre-processing training stage 202, a training dataset that is used to train an ML model is pre-processed by removing or replacing sensitive information in the dataset with generic information, preparing and cleaning the data, performing data validation checks on the data and so on.

The feature extraction training stage 204 may operate on the pre-processed training dataset to extract relevant signals (features) from the pre-processed training dataset for the model training stage 206. A feature may represent a column of data in the training dataset. For instance, if an ML model is used to predict a type of car that a person will buy, the input features may include age, region, income and the like. The feature extraction training stage 204 may additionally process the training dataset to reduce the number of features in the dataset by creating new features from existing ones (i.e., original set of features) that summarize the information contained in the original set of features. A customer may use a feature extraction API in the SDK to write code (logic) for the feature extraction training stage 204. The feature extraction API may, for example, identify create/view new types of feature extractors to extract features from the training dataset. The model training stage 206, the post-processing training stage 208 and the model evaluation training stage 210 in the ML training pipeline 214 are similar to the model training stage 108, the post-processing training stage 110 and the model evaluation training stage 112 in the ML training pipeline 102 shown in FIG. 1.

The mapping system 216 (which is similar to the mapping system 122 described in FIG. 1) may be configured to receive a pre-processing artifact 203 (i.e., the pre-processing code) that identifies the processing to be performed for the pre-processing training stage and a feature extraction artifact 205 that identifies processing to be performed for the feature extraction training stage and serializes the artifacts to generate a serialized pre-processing artifact and a serialized feature extraction artifact. The mapping system then identifies the stages in the ML inference pipeline that correspond to the training stages in the ML training pipeline.

For instance, in the embodiment depicted in FIG. 2, the mapping system 216 may identify (based on the mapping rules described in FIG. 1) that both the pre-processing training stage 202 and the feature extraction training stage 204 correspond to a single inference stage (e.g., the pre-transformer inference stage 220) in the ML inference pipeline 218. In this case, the mapping system 216 may associate the pre-processing artifact 203 received for the pre-processing training stage 202 and the feature extraction artifact 205 received for the feature extraction training stage 204 to the pre-transformer inference stage 220 in the ML inference pipeline 218. The mapping system 216 may additionally associate the trained model artifact 207 with the estimator inference stage 222 and the post-processing artifact 209 with the post-transformer inference stage 224 in the ML inference pipeline 218. The inference pipeline 218 comprising the pre-transformer inference stage 220, the estimator inference stage 222 and the post-transformer inference stage 224 are implemented in a similar manner to the ML inference pipeline 130 described in FIG. 1.

After associating the artifacts received for the training stages with their corresponding inference stages as described above, the mapping system 216 generates an ML inference pipeline 218 comprising the identified inference stages (e.g., 220, 222 and 224) and their associated artifacts (e.g., 203, 205, 207 and 209). The mapping system 216 then generates a package 226 that implements the ML inference pipeline 218, where the package 226 includes the artifacts associated with the inference stages in the inference pipeline. The mapping system 216 then deploys the package 226 in an inference environment where an inference server 228 can execute the package as described in FIG. 1.

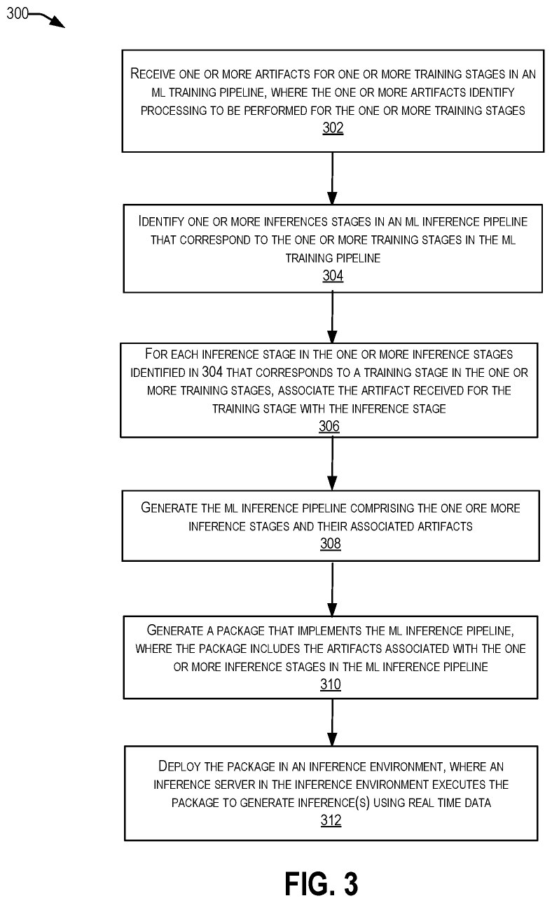

FIG. 3 depicts an example of a process 300 by which the mapping system shown in FIG. 1 generates and deploys a package that implements the inference pipeline using artifacts received from one or more training stages in a ML training pipeline, according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 300 presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 3 may be performed by the mapping system 122.

The processing depicted in FIG. 3 may be initiated when, at block 302, the mapping system 122 receives one or more artifacts for one or more training stages in an ML training pipeline, where the artifacts identify processing to be performed for the training stages. The artifacts may represent code, a set of instructions, a script, or a configuration file that identifies processing to be performed for the one or more training stages in the ML training pipeline. As previously described in FIG. 1, in certain examples, the artifacts include a pre-processing artifact (e.g., 116) that identifies pre-processing that is performed on the training dataset, a trained model artifact (e.g., 118) that identifies processing that is performed to generate a trained model and a post-processing artifact (e.g., 120) that identifies post-processing that is performed on the prediction(s) generated by the trained model. The system 122 receives the artifacts and serializes the artifacts by persisting (storing) the artifacts as binary files, for example, in persistent memory in the system.

At block 304, the mapping system 304 identifies one or more inference stages in an ML inference pipeline that correspond to the one or more training stages in the ML training pipeline. As previously noted, the mapping system may utilize a set of mapping rules to identify the inference stages in an inference pipeline that correspond to the training stages in the training pipeline. For example, in the embodiment depicted in FIG. 1, the mapping system 122 may identify, based on the mapping rules, that the pre-processing training stage 106 corresponds to the pre-transformer inference stage 132, the model training stage 108 corresponds to the estimator inference stage 134 and the post-processing training stage 110 corresponds to the post-transformer inference stage 136 in the inference pipeline.

At block 306, for each inference stage in the inference stages identified in block 304 that corresponds to a training stage in the one or more training stages, the system associates the artifact received for the training stage with the inference stage. In the embodiment shown in FIG. 1, for example, the pre-processing artifact (e.g., 116) is associated with the pre-transformer inference stage 132 in the ML inference pipeline 130, the trained model artifact (e.g., 118) is associated with the estimator inference stage 134 and the post-processing artifact (e.g., 120) is associated with the post-transformer inference stage in the ML inference pipeline.

At block 308, the system generates the ML inference pipeline comprising the one or more inference stages and their associated artifacts.

At block 310, the system generates a package that implements the ML inference pipeline, where the package includes the artifacts associated with the one or more inference stages in the ML inference pipeline.

At block 312, the system deploys the package in an inference environment, where an inference server (e.g., 134) in the inference environment executes the package which is used to generate inferences or predictions on real time data.

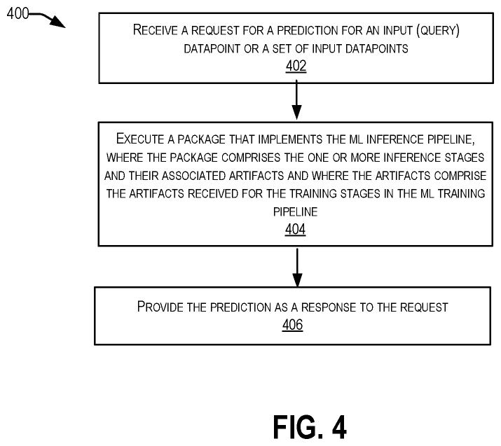

FIG. 4 depicts an example of a process 400 that describes the operations performed by an inference server for executing a package that implements an ML inference pipeline using artifacts received from one or more training stages in a ML training pipeline, according to certain embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 400 presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 4 may be performed by the inference server 134.

The processing depicted in FIG. 4 may be initiated when the inference server receives a request for prediction for an input (query) datapoint (e.g., 144) or an input (query) dataset (comprising a set of one or more input data points). For instance, as depicted in FIG. 1, a user (e.g., 140) may transmit the request for prediction for an input datapoint or an input dataset via a user device (e.g., 142) to an inference endpoint (address or URL) of the inference server 134.

At block 404, the inference server executes a package (e.g., 132) that implements the ML inference pipeline. The package comprises one or more inference stages and their associated artifacts where the artifacts comprise the artifacts received for the training stages in the ML training pipeline. For instance, referring to the embodiment depicted in FIG. 1, the inference server 132 executes the package by executing the serialized pre-processing artifact 124 to pre-process the query datapoint (or query dataset). The inference server then executes the serialized trained model artifact 134 using the pre-processed query datapoint (or dataset) to generate a prediction (or multiple predictions) and then executes the serialized post-processing artifact 126 to post-process the prediction(s) generated by the trained model.

At block 406 the inference server provides the prediction (or predictions) responsive to the request to the user.

In certain embodiments, the ML training pipeline to ML inference pipeline mapping functionality may be provided as a service by an Infrastructure-as-a-Service (IaaS) provider. The following section describes an example IaaS infrastructure that may be used to implement the service.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

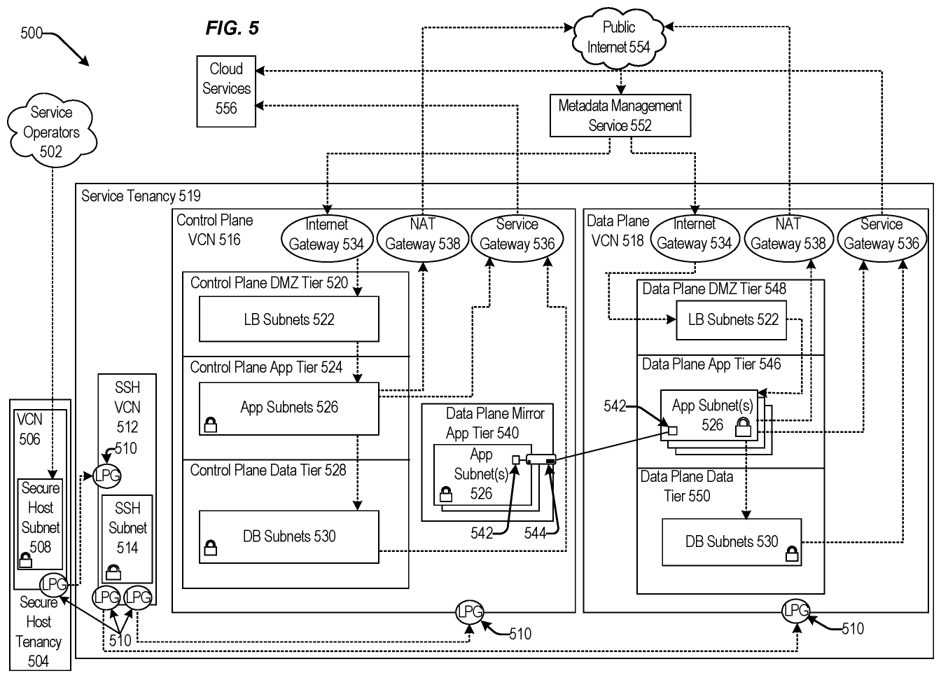

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry®, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Memory that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

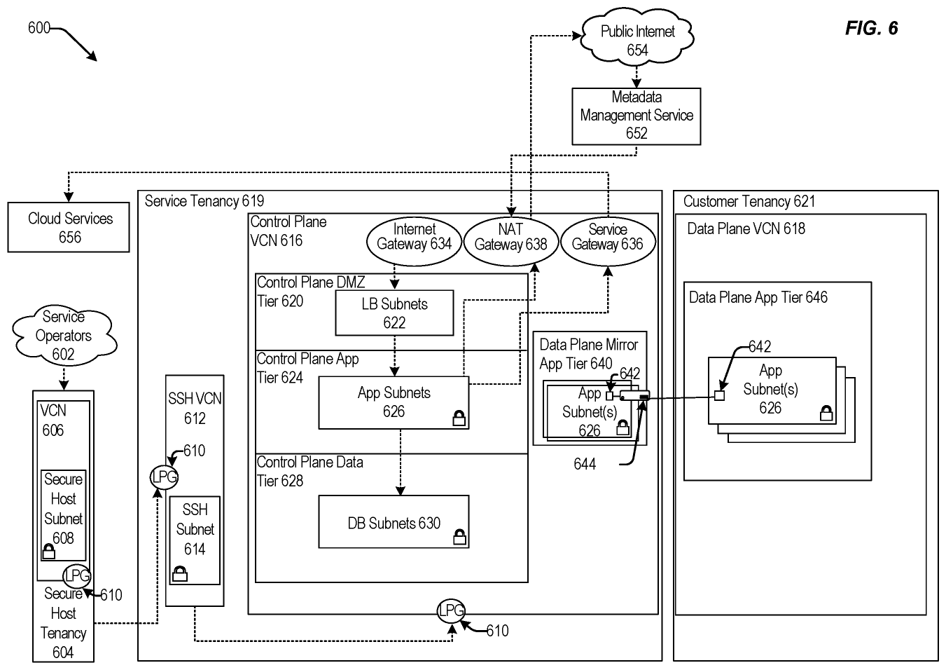

FIG. 6 is a block diagram 600 illustrating another example pattern of an IaaS architecture, according to at least one embodiment. Service operators 602 (e.g. service operators 502 of FIG. 5) can be communicatively coupled to a secure host tenancy 604 (e.g. the secure host tenancy 504 of FIG. 5) that can include a virtual cloud network (VCN) 606 (e.g. the VCN 506 of FIG. 5) and a secure host subnet 608 (e.g. the secure host subnet 508 of FIG. 5). The VCN 606 can include a local peering gateway (LPG) 610 (e.g. the LPG 510 of FIG. 5) that can be communicatively coupled to a secure shell (SSH) VCN 612 (e.g. the SSH VCN 512 of FIG. 5) via an LPG 510 contained in the SSH VCN 612. The SSH VCN 612 can include an SSH subnet 614 (e.g. the SSH subnet 514 of FIG. 5), and the SSH VCN 612 can be communicatively coupled to a control plane VCN 616 (e.g. the control plane VCN 516 of FIG. 5) via an LPG 610 contained in the control plane VCN 616. The control plane VCN 616 can be contained in a service tenancy 619 (e.g. the service tenancy 519 of FIG. 5), and the data plane VCN 618 (e.g. the data plane VCN 518 of FIG. 5) can be contained in a customer tenancy 621 that may be owned or operated by users, or customers, of the system.

The control plane VCN 616 can include a control plane DMZ tier 620 (e.g. the control plane DMZ tier 520 of FIG. 5) that can include LB subnet(s) 622 (e.g. LB subnet(s) 522 of FIG. 5), a control plane app tier 624 (e.g. the control plane app tier 524 of FIG. 5) that can include app subnet(s) 626 (e.g. app subnet(s) 526 of FIG. 5), a control plane data tier 628 (e.g. the control plane data tier 528 of FIG. 5) that can include database (DB) subnet(s) 630 (e.g. similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g. the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g. the service gateway of FIG. 5) and a network address translation (NAT) gateway 638 (e.g. the NAT gateway 538 of FIG. 5). The control plane VCN 616 can include the service gateway 636 and the NAT gateway 638.

The control plane VCN 616 can include a data plane mirror app tier 640 (e.g. the data plane mirror app tier 540 of FIG. 5) that can include app subnet(s) 626. The app subnet(s) 626 contained in the data plane mirror app tier 640 can include a virtual network interface controller (VNIC) 642 (e.g. the VNIC of 542) that can execute a compute instance 644 (e.g. similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g. the metadata management service 552 of FIG. 5) that can be communicatively coupled to public Internet 654 (e.g. public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g. cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

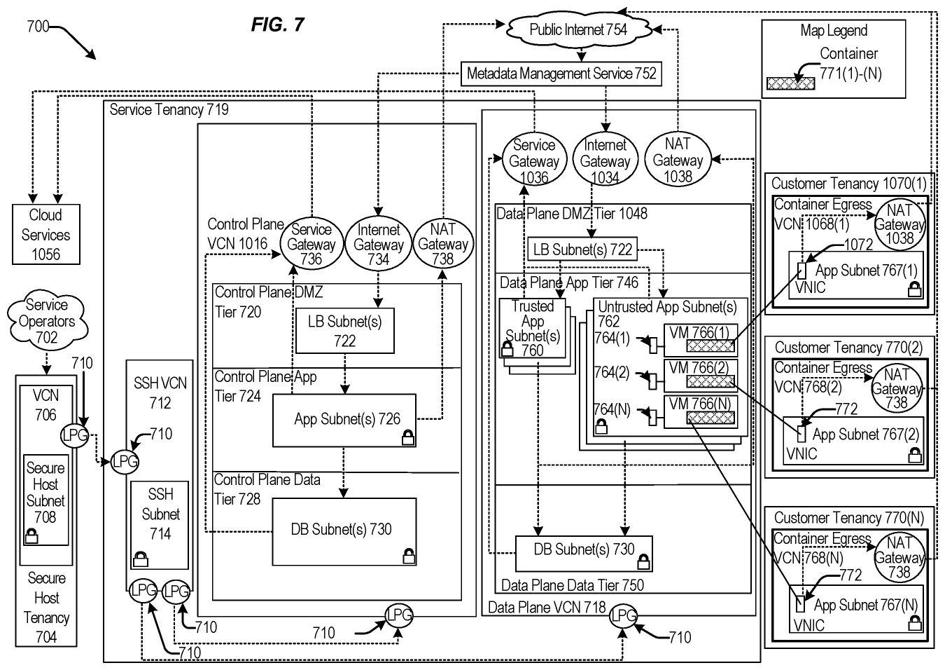

FIG. 7 is a block diagram 700 illustrating another example pattern of an IaaS architecture, according to at least one embodiment. Service operators 702 (e.g. service operators 502 of FIG. 5) can be communicatively coupled to a secure host tenancy 704 (e.g. the secure host tenancy 504 of FIG. 5) that can include a virtual cloud network (VCN) 706 (e.g. the VCN 506 of FIG. 5) and a secure host subnet 708 (e.g. the secure host subnet 508 of FIG. 5). The VCN 706 can include an LPG 710 (e.g. the LPG 510 of FIG. 5) that can be communicatively coupled to an SSH VCN 712 (e.g. the SSH VCN 512 of FIG. 5) via an LPG 710 contained in the SSH VCN 712. The SSH VCN 712 can include an SSH subnet 714 (e.g. the SSH subnet 514 of FIG. 5), and the SSH VCN 712 can be communicatively coupled to a control plane VCN 716 (e.g. the control plane VCN 516 of FIG. 5) via an LPG 710 contained in the control plane VCN 716 and to a data plane VCN 718 (e.g. the data plane 518 of FIG. 5) via an LPG 710 contained in the data plane VCN 718. The control plane VCN 716 and the data plane VCN 718 can be contained in a service tenancy 719 (e.g. the service tenancy 519 of FIG. 5).

The control plane VCN 716 can include a control plane DMZ tier 720 (e.g. the control plane DMZ tier 520 of FIG. 5) that can include load balancer (LB) subnet(s) 722 (e.g. LB subnet(s) 522 of FIG. 5), a control plane app tier 724 (e.g. the control plane app tier 524 of FIG. 5) that can include app subnet(s) 726 (e.g. similar to app subnet(s) 526 of FIG. 5), a control plane data tier 728 (e.g. the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g. the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g. the service gateway of FIG. 5) and a network address translation (NAT) gateway 738 (e.g. the NAT gateway 538 of FIG. 5). The control plane VCN 716 can include the service gateway 736 and the NAT gateway 738.

The data plane VCN 718 can include a data plane app tier 746 (e.g. the data plane app tier 546 of FIG. 5), a data plane DMZ tier 748 (e.g. the data plane DMZ tier 548 of FIG. 5), and a data plane data tier 750 (e.g. the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g. public Internet 554 of FIG. 5).

The Internet gateway 734 contained in the control plane VCN 716 and contained in the data plane VCN 718 can be communicatively coupled to a metadata management service 752 (e.g. the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

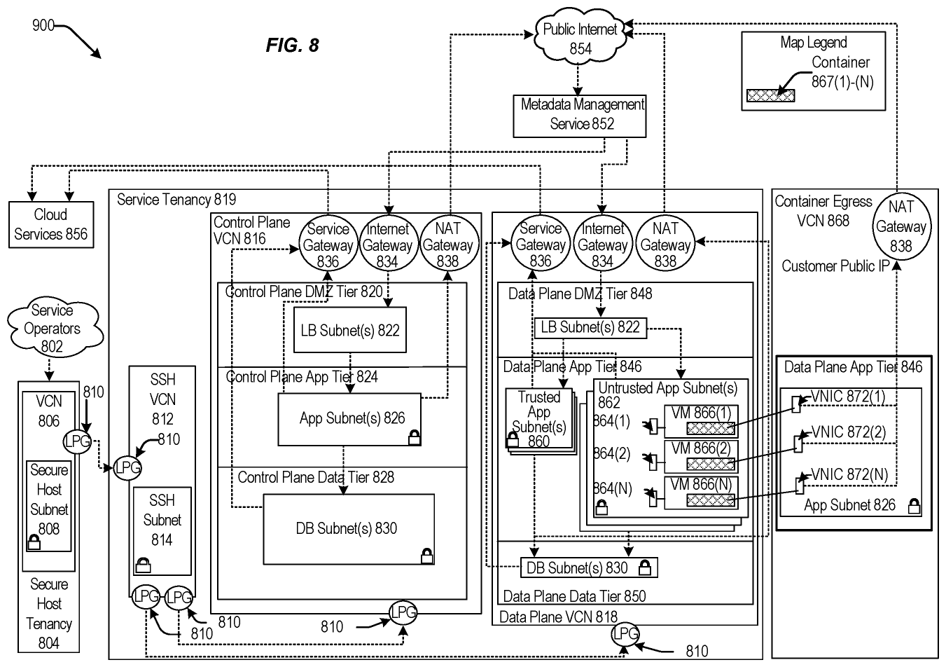

FIG. 8 is a block diagram 800 illustrating another example pattern of an IaaS architecture, according to at least one embodiment. Service operators 802 (e.g. service operators 502 of FIG. 5) can be communicatively coupled to a secure host tenancy 804 (e.g. the secure host tenancy 504 of FIG. 5) that can include a virtual cloud network (VCN) 806 (e.g. the VCN 506 of FIG. 5) and a secure host subnet 808 (e.g. the secure host subnet 508 of FIG. 5). The VCN 806 can include an LPG 810 (e.g. the LPG 510 of FIG. 5) that can be communicatively coupled to an SSH VCN 812 (e.g. the SSH VCN 512 of FIG. 5) via an LPG 810 contained in the SSH VCN 812. The SSH VCN 812 can include an SSH subnet 814 (e.g. the SSH subnet 514 of FIG. 5), and the SSH VCN 812 can be communicatively coupled to a control plane VCN 816 (e.g. the control plane VCN 516 of FIG. 5) via an LPG 810 contained in the control plane VCN 816 and to a data plane VCN 818 (e.g. the data plane 518 of FIG. 5) via an LPG 810 contained in the data plane VCN 818. The control plane VCN 816 and the data plane VCN 818 can be contained in a service tenancy 819 (e.g. the service tenancy 519 of FIG. 5).

The control plane VCN 816 can include a control plane DMZ tier 820 (e.g. the control plane DMZ tier 520 of FIG. 5) that can include LB subnet(s) 822 (e.g. LB subnet(s) 522 of FIG. 5), a control plane app tier 824 (e.g. the control plane app tier 524 of FIG. 5) that can include app subnet(s) 826 (e.g. app subnet(s) 526 of FIG. 5), a control plane data tier 828 (e.g. the control plane data tier 528 of FIG. 5) that can include DB subnet(s) 830 (e.g. DB subnet(s) 1030 of FIG. 10). The LB subnet(s) 822 contained in the control plane DMZ tier 820 can be communicatively coupled to the app subnet(s) 826 contained in the control plane app tier 824 and to an Internet gateway 834 (e.g. the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 5) and a network address translation (NAT) gateway 838 (e.g. the NAT gateway 538 of FIG. 5). The control plane VCN 816 can include the service gateway 836 and the NAT gateway 838.

The data plane VCN 818 can include a data plane app tier 846 (e.g. the data plane app tier 546 of FIG. 5), a data plane DMZ tier 848 (e.g. the data plane DMZ tier 548 of FIG. 5), and a data plane data tier 850 (e.g. the data plane data tier 550 of FIG. 5). The data plane DMZ tier 848 can include LB subnet(s) 822 that can be communicatively coupled to trusted app subnet(s) 860 (e.g. trusted app subnet(s) 1060 of FIG. 10) and untrusted app subnet(s) 862 (e.g. untrusted app subnet(s) 1062 of FIG. 10) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g. public Internet 554 of FIG. 5).

The Internet gateway 834 contained in the control plane VCN 816 and contained in the data plane VCN 818 can be communicatively coupled to a metadata management service 852 (e.g. the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 500 of FIG. 5 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

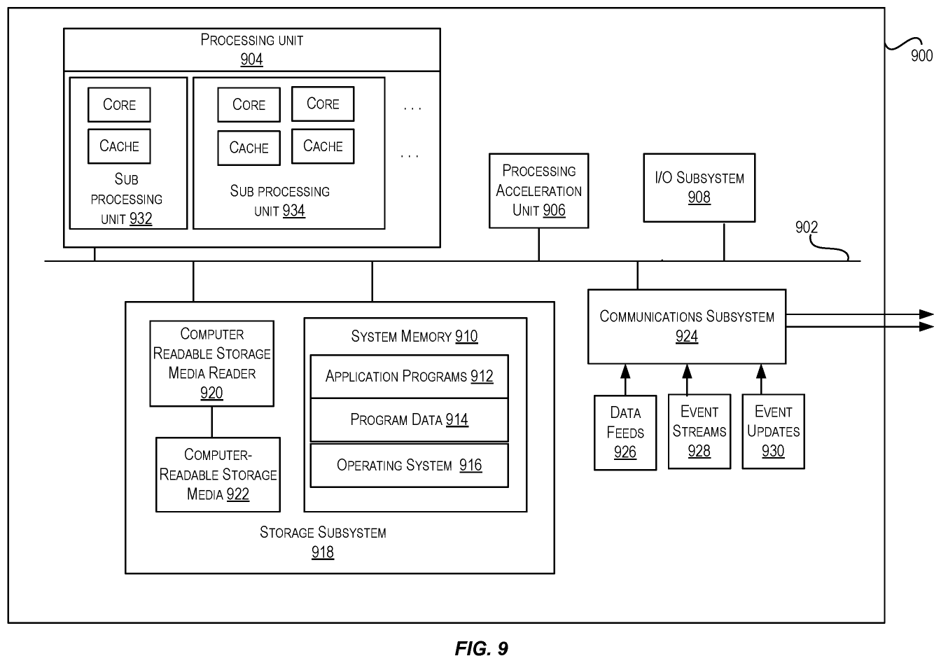

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 9 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
for a Machine Learning (ML) training pipeline associated with a Machine Learning (ML) process, wherein the ML training pipeline comprises a set of training stages, receiving, by a system, one or more artifacts for one or more training stages in the set of training stages in the ML training pipeline;
identifying, by the system, one or more inference stages in a Machine Learning (ML) inference pipeline associated with the ML process that correspond to the one or more training stages in the ML training pipeline;
for each inference stage in the one or more inference stages that corresponds to a training stage in the one or more training stages, associating, by the system, the artifact received for the training stage with the inference stage; and
generating, by the system, the ML inference pipeline comprising the one or more inference stages and their associated artifacts, wherein the artifacts comprise the one or more artifacts received for the one or more training stages in the ML training pipeline.

2. The computer-implemented method of claim 1, wherein the one or more artifacts represent code, a set of instructions, a script, or a configuration file that identifies processing to be performed for the one or more training stages in the ML training pipeline.

3. The computer-implemented method of claim 1, wherein the one or more artifacts comprise a pre-processing artifact, wherein the pre-processing artifact identifies pre-processing to be performed for a pre-processing training stage in the ML training pipeline, wherein a training stage in the one or more training stages in the ML training pipeline comprises the pre-processing training stage.

4. The computer-implemented method of claim 1, wherein the one or more artifacts comprise a trained model artifact, wherein the trained model artifact identifies processing to be performed for a model training stage in the ML training pipeline, wherein a training stage in the one or more training stages in the ML training pipeline comprises the model training stage.

5. The computer-implemented method of claim 1, wherein the one or more artifacts comprise a post-processing artifact, wherein the post-processing artifact identifies post-processing to be performed for a post-processing training stage in the ML training pipeline, wherein a training stage in the one or more training stages in the ML training pipeline comprises the post-processing training stage.

6. The computer-implemented method of claim 1 further comprising, providing, by the system, a set of Application Programming Interfaces (APIs), wherein an API in the set of APIs identifies the processing to be performed for a particular training stage in the set of training stages in the ML training pipeline.

7. The computer-implemented method of claim 1 further comprising:
generating, by the system, a package that implements the ML inference pipeline, wherein the package comprises the one or more artifacts associated with the one or more inference stages in the ML inference pipeline; and
deploying, by the system, the package in an inference environment, wherein an inference server implemented in the inference environment executes the package to generate inferences on real time data.

8. The computer-implemented method of claim 7, further comprising:
receiving, by the inference server, a request for a prediction for a set of one or more input datapoints;
executing, by the inference server, the package that implements the inference pipeline, wherein the package comprises the one or more inference stages and their associated artifacts and wherein the artifacts comprise the one or more artifacts received for the one or more training stages in the ML training pipeline; and
responsive to the executing, providing, by the inference server, the prediction as a response to the request.

9. The computer-implemented method of claim 8, wherein executing, by the inference server, the package that implements the inference pipeline comprises:
executing, by the inference server, a pre-processing artifact in the package to pre-process the set of one or more datapoints to generate a set of pre-processed datapoints, executing a trained model artifact in the package using the set of pre-processed datapoints to generate the prediction and executing a post-processing artifact in the package to post-process the prediction generated by the trained model artifact.

10. The computer-implemented method of claim 1, further comprising serializing, by the system, the one or more artifacts received for the one or more training stages prior to associating, by the system, the one or more artifacts with the one or more inference stages.

11. A system comprising:
a memory; and
one or more processors configured to perform processing comprising:
receiving one or more artifacts for one or more training stages in a set of training stages in a Machine Learning (ML) training pipeline associated with a Machine Learning (ML) process;
identifying one or more inference stages in a Machine Learning (ML) inference pipeline associated with the ML process that correspond to the one or more training stages in the ML training pipeline;
for each inference stage in the one or more inference stages that corresponds to a training stage in the one or more training stages, associating the artifact received for the training stage with the inference stage; and
generating the ML inference pipeline comprising the one or more inference stages and their associated artifacts, wherein the artifacts comprise the one or more artifacts received for the one or more training stages in the ML training pipeline.

12. The system of claim 11, wherein the one or more artifacts represent code, a set of instructions, a script, or a configuration file that identifies processing to be performed for the one or more training stages in the ML training pipeline.

13. The system of claim 11 further comprising:
generating a package that implements the ML inference pipeline, wherein the package comprises the one or more artifacts associated with the one or more inference stages in the ML inference pipeline; and
deploying the package in an inference environment, wherein an inference server implemented in the inference environment executes the package to generate inferences on real time data.

14. The system of claim 11, further comprising:
receiving, by the inference server, a request for a prediction for a set of one or more input datapoints;
executing, by the inference server, the package that implements the inference pipeline, wherein the package comprises the one or more inference stages and their associated artifacts and wherein the artifacts comprise the one or more artifacts received for the one or more training stages in the ML training pipeline; and
responsive to the executing, providing, by the inference server, the prediction as a response to the request.

15. The system of claim 11, further comprising serializing the one or more artifacts received for the one or more training stages prior to associating the one or more artifacts with the one or more inference stages.

16. A non-transitory computer-readable medium having program code that is stored thereon, the program code executable by one or more processing devices for performing operations comprising:
receiving one or more artifacts for one or more training stages in a set of training stages in a Machine Learning (ML) training pipeline associated with a Machine Learning (ML) process;
identifying one or more inference stages in a Machine Learning (ML) inference pipeline associated with the ML process that correspond to the one or more training stages in the ML training pipeline;
for each inference stage in the one or more inference stages that corresponds to a training stage in the one or more training stages, associating the artifact received for the training stage with the inference stage; and
generating the ML inference pipeline comprising the one or more inference stages and their associated artifacts, wherein the artifacts comprise the one or more artifacts received for the one or more training stages in the ML training pipeline.

17. The non-transitory computer-readable medium of claim 16, wherein the one or more artifacts comprise a pre-processing artifact, wherein the pre-processing artifact identifies pre-processing to be performed for a pre-processing training stage in the ML training pipeline, wherein a training stage in the one or more training stages in the ML training pipeline comprises the pre-processing training stage.

18. The non-transitory computer-readable medium of claim 16, wherein the one or more artifacts comprise a trained model artifact, wherein the trained model artifact identifies processing to be performed for a model training stage in the ML training pipeline, wherein a training stage in the one or more training stages in the ML training pipeline comprises the model training stage.

19. The non-transitory computer-readable medium of claim 16, wherein the one or more artifacts comprise a post-processing artifact, wherein the post-processing artifact identifies post-processing to be performed for a post-processing training stage in the ML training pipeline, wherein a training stage in the one or more training stages in the ML training pipeline comprises the post-processing training stage.

20. The non-transitory computer-readable medium of claim 16 further comprising:
generating a package that implements the ML inference pipeline, wherein the package comprises the one or more artifacts associated with the one or more inference stages in the ML inference pipeline; and
deploying the package in an inference environment, wherein an inference server implemented in the inference environment executes the package to generate inferences on real time data.
